(19) United States
(12) Patent Application Publication
(10) Pub. No.: US 2013/0273437 A1
(43) Pub. Date: Oct. 17, 2013

(54) ALL SOLID STATE BATTERY

(71) Applicant: MURATA MANUFACTURING CO., LTD., Nagaokakyo-Shi (JP)

(72) Inventors: Makoto Yoshioka, Nagaokakyo-Shi (JP); Masutaka Ouchi, Nagaokakyo-Shi (JP); Takeshi Hayashi, Nagaokakyo-Shi (JP); Kunio Nishida, Nagaokakyo-Shi (JP)

(73) Assignee: Murata Manufacturing Co., Ltd., Nagaokakyo-shi (JP)

(21) Appl. No.: 13/713,028

(22) Filed: Dec. 13, 2012

Related U.S. Application Data
(63) Continuation of application No. PCT/JP2011/065831, filed on Jul. 12, 2011.

(30) Foreign Application Priority Data
Jul. 12, 2010 (JP) 2010-157529

(51) Int. Cl. H01M 10/0562

(52) U.S. Cl. CPC H01M 10/0562
USPC 429/322; 429/209; 429/231.5; 429/218.1; 429/221; 429/223; 429/224; 429/220

(57) ABSTRACT

Provided is an all solid state battery which has the same level of discharge capacity as in the case of using an electrolyte solution, and is able to improve the cycle stability. An all solid state battery includes a solid electrolyte layer, as well as a positive electrode layer and a negative electrode layer provided in positions opposed to each other with the solid electrolyte layer interposed therebetween. At least one of the positive electrode layer and the negative electrode layer is bonded to the solid electrolyte layer by firing. The negative electrode layer contains an electrode active material composed of a metal oxide containing no lithium, and a solid electrolyte containing no titanium.

### CROSS REFERENCE TO RELATED APPLICATIONS

The present application is a continuation of International application No. PCT/JP2011/065831, filed Jul. 12, 2011, which claims priority to Japanese Patent Application No. 2010-157529, filed Jul. 12, 2010, the entire contents of each of which are incorporated herein by reference.

### FIELD OF THE INVENTION

The present invention generally relates to an all solid state battery, and more particularly relates to an all solid state battery including a solid electrolyte layer, a positive electrode layer, and a negative electrode layer, in which at least one of the positive electrode layer and the negative electrode layer is bonded to the solid electrolyte layer by firing.

### BACKGROUND OF THE INVENTION

In recent years, the demand for batteries has been expanded drastically as power sources for mobile electronic devices such as cellular phones and portable personal computers. In batteries for use in these applications, electrolytes (electrolyte solutions) such as organic solvents have been used conventionally as media for transferring ions.

However, the batteries configured as described above are at risk for leaking the electrolyte solutions. In addition, the organic solvents, etc. for use in the electrolyte solutions have the problem of being flammable substances. Therefore, the use of solid electrolytes in place of the electrolyte solutions has been proposed. Further, the development of all solid state batteries has been advanced which use solid electrolytes as electrolytes, and also have other components composed of solids.

For example, Japanese Patent Application Laid-Open No. 2007-5279 (hereinafter, referred to as Patent Document 1) proposes an all solid state battery which uses a nonflammable solid electrolyte, and has all components composed of solids. Patent Document 1 discloses a method for manufacturing an all solid state battery by stacking and firing an electrode layer containing an electrode active material and a solid electrolyte layer containing a solid electrolyte.

In addition, for example, Japanese Patent Application Laid-Open No. 2009-181921 (hereinafter, referred to as Patent Document 2) discloses, in Examples 1 to 4, examples of preparing an all solid state battery with the use of Li_{1+x+y}AlₓTi₂₋ₓSi_{y}P_{3-y}O₁₂ (0≦x≦0.4, 0<y≦0.6) (hereinafter, referred to as LASTP) as a solid electrolyte, and silicon oxide or anatase-type titanium oxide as an electrode active material for a negative electrode. In addition, Patent Document 2 discloses, as a method for manufacturing an all solid state battery, preparing green sheets for a solid electrolyte, a positive electrode, and a negative electrode by a doctor blade method, placing the green sheets for a positive electrode and a negative electrode on both sides of the solid electrolyte green sheet, pressure-bonding the sheets to prepare a laminated body, and integrally firing the laminated body pinched by a setter.
Patent Document 1: Japanese Patent Application Laid-Open No. 2007-5279
Patent Document 2: Japanese Patent Application Laid-Open No. 2009-181921

### SUMMARY OF THE INVENTION

However, in the method disclosed in Patent Document 1, the electrode active material in the electrode layer is converted in firing the laminated body, thus leading to a problem of decreased battery discharge capacity as compared with cases using electrolyte solutions.

In addition, the inventors have found that, for the all solid state battery disclosed in Patent Document 2, the solid electrolyte is reduced around the charge-discharge potential of the electrode active material, because the LASTP containing titanium is used as the solid electrolyte, whereas silicon oxide containing no lithium, or titanium oxide is used as the electrode active material for the negative electrode. As a result, the inventors have found that the solid electrolyte is decomposed or reacted to decrease the ion conductivity of the negative electrode. Therefore, the all solid state battery disclosed in Patent Document 2 causes a problem of failing to stabilize the discharge capacity of the battery, and decreasing the discharge capacity when charge and discharge are carried out repeatedly, that is, lack of cycle stability.

Therefore, an object of the present invention is to provide an all solid state battery which has the same level of discharge capacity as in the case of using an electrolyte solution, and is able to improve the cycle stability.

The inventors have found, as a result of carrying out various studies in order to solve the problems described above, that the all solid state battery prepared with the use of a metal oxide containing no lithium as an electrode active material for a negative electrode, and with the use of a solid electrolyte containing no titanium for the negative electrode, not only has the same level of discharge capacity as in the case of using an electrolyte solution, but also has improved cycle stability. Based on the finding made by the inventors, the present invention includes the following features.

The all solid state battery in accordance with the present invention includes a solid electrolyte layer, as well as a positive electrode layer and a negative electrode layer provided in positions opposed to each other with the solid electrolyte layer interposed therebetween. At least one of the positive electrode layer and the negative electrode layer is bonded to the solid electrolyte layer by firing. The negative electrode layer contains an electrode active material composed of a metal oxide containing no lithium, and a solid electrolyte containing no titanium.

In the all solid state battery according to the present invention, the metal oxide constituting the electrode active material of the negative electrode layer preferably contains at least one element selected from the group consisting of titanium, silicon, tin, chromium, iron, molybdenum, niobium, nickel, manganese, cobalt, copper, tungsten, vanadium, and ruthenium.

In addition, in the all solid state battery according to the present invention, the solid electrolyte contained in the negative electrode layer preferably contains a lithium-containing phosphate compound. In addition, the lithium-containing phosphate compound contained in the negative electrode layer preferably contains a lithium-containing phosphate compound having a NASICON-type structure.

Furthermore, in the all solid state battery according to the present invention, the solid electrolyte contained in the solid electrolyte layer preferably contains a lithium-containing phosphate compound. In this case, the lithium-containing phosphate compound contained in the solid electrolyte layer preferably contains a lithium-containing phosphate compound having a NASICON-type structure.

The all solid state battery prepared with the use of a metal oxide containing no lithium as an electrode active material for a negative electrode, and with the use of a solid electrolyte containing no titanium for the negative electrode, not only has the same level of discharge capacity as in the case of using an electrolyte solution, but also has improved cycle stability.

### BRIEF EXPLANATION OF THE DRAWINGS

FIG. 1 is a cross-sectional view schematically illustrating a cross-sectional structure of an all solid state battery as an embodiment of the present invention.

### DETAILED DESCRIPTION OF THE INVENTION

An embodiment of the present invention will be described below.

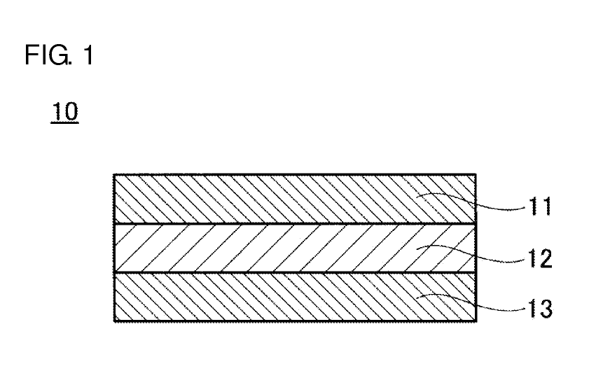

As shown in FIG. 1, an all solid state battery 10 includes a solid electrolyte layer 12, as well as a positive electrode layer 11 and a negative electrode layer 13 provided in positions opposed to each other with the solid electrolyte layer 12 interposed therebetween. At least one of the positive electrode layer 11 and the negative electrode layer 13 is bonded to the solid electrolyte layer 12 by firing. The negative electrode layer 13 contains an electrode active material composed of a metal oxide containing no lithium, and a solid electrolyte containing no titanium.

First, the use of the metal oxide as an electrode active material for the negative electrode layer 13 allows the preparation of the all solid state battery 10 which has the same level of discharge capacity as in the case of using an electrolyte solution, without converting the electrode active material contained in the negative electrode layer 13 when a laminated body including the positive electrode layer 11, the solid electrolyte layer 12, and the negative electrode layer 13 is subjected to firing.

In addition, the use of the metal oxide containing no lithium as an electrode active material for the negative electrode layer 13, and the use of the solid electrolyte containing no titanium for the negative electrode layer 13 can suppress the decrease in the ion conductivity of the negative electrode layer through the decomposition or reaction of the solid electrolyte, because of the solid electrolyte reduced around the charge-discharge potential of the electrode active material. As a result, the all solid state battery 10 according to the present invention can develop a high capacity which is essentially provided by the electrode active material, and allows for stably repeated change and discharge because the solid electrolyte is not decomposed or reacted. Therefore, the all solid state battery prepared with the use of the metal oxide containing no lithium as an electrode active material for the negative electrode later 13, and with the use of the solid electrolyte containing no titanium for the negative electrode layer 13, not only has the same level of discharge capacity as in the case of using an electrolyte solution, but also has improved cycle stability.

In the all solid state battery 10 according to the present invention, the metal oxide constituting the electrode active material of the negative electrode layer 13 preferably contains at least one element selected from the group consisting of titanium (Ti), silicon (Si), tin (Sn), chromium (Cr), iron (Fe), molybdenum (Mo), niobium (Nb), nickel (Ni), manganese (Mn), cobalt (Co), copper (Cu), tungsten (W), vanadium (V), and ruthenium (Ru). The use of the above metal oxide as an electrode active material for the negative electrode layer 13 can achieve an all solid state battery which has a high capacity density, and has a higher energy density as the battery voltage is increased. In order to achieve the battery more effectively, it is preferable to use, as the metal oxide described above, a metal oxide which has a high capacity per weight and has a low electric potential with respect to lithium. A compound which has a composition represented by MOₓ (M is at least one or more elements selected from the group consisting of Ti, Si, Sn, Cr, Fe, Mo, Nb, Ni, Mn, Co, Cu, W, V, and Ru, and x is a numerical value within the range of 0.5≦x≦3.0) can be used as the metal oxide which exhibits these features. In particular, it is preferable to use anatase-type TiO₂, rutile-type TiO₂, brookite-type TiO₂, SiO, SnO, SnO₂, Cr₂O₃, Fe₂O₃, MoO₂, Nb₂O₅, NiO, MnO, CoO, Cu₂O, CuO, WO₂, V₂O₅, and RuO₂.

It is to be noted that a mixture of two or more mixed compounds which have compositions represented by MOₓ containing different elements M, such as, for example, TiO₂ and SiO₂, may be used as the electrode active material of the negative electrode layer 13. In addition, the compound which has a composition represented by MOₓ may use therein a solid solution which has a composition with some of the element M substituted with a different M, or a composition with some of the element M substituted with P, F, or the like. Furthermore, the compound which has a composition represented by MOₓ may have a surface coated with a conducting agent containing carbon as its main constituent, or have the conducting agent supported on the surface.

The solid electrolyte contained in the negative electrode layer 13 preferably contains a lithium-containing phosphate compound containing no titanium, and further, the lithium-containing phosphate compound preferably contains a lithium-containing phosphate compound having a NASICON-type structure. The lithium-containing phosphate compound having a NASICON-type structure is represented by the chemical formula LiₓM_{y}(PO₄)₃ (wherein x is a numerical value within the range of 1≦x≦3, y is a numerical value within the range of 1≦y≦2, and M is one or more elements selected from the group consisting of Ge, Al, Ga, Zr, Fe, and Nb). In this case, some of P may be substituted with B, Si, or the like in the above chemical formula. For example, Li_{1.5}Al_{0.5}Ge_{1.5}(PO₄)₃, Li_{3.0}Fe_{1.8}Zr_{0.2}(PO₄)₃, etc. can be used. Alternatively, a mixture may be used which has two or more mixed lithium-containing phosphate compounds having NASICON-type structures with different compositions.

Compounds including a crystalline phase of a lithium-containing phosphate compound having a NASICON-type structure, or glass for precipitating a crystalline phase of a lithium-containing phosphate compound having a NASICON-type structure through a heat treatment may be used as the lithium-containing phosphate compound having a NASICON-type structure, which is used for the solid electrolyte contained in the negative electrode layer 13 described above.

It is to be noted that it is possible to use, as the material used for the solid electrolyte contained in the negative electrode layer 13, materials which have ion conductivity and have negligibly low electron conductivity, besides the lithium-containing phosphate compound having a NASICON-type structure. Examples of these materials include lithium halides, lithium nitrides, lithium oxoates, and derivatives thereof. In addition, examples of the materials can also include Li—P—O-based compounds such as lithium phosphate (Li₃PO₄), LIPON (LiPO₄₋ₓNₓ) of lithium phosphate with nitrogen introduced therein, Li—Si—O-based compounds such as Li₄SiO₄, Li—P—Si—O-based compounds, Li—V—Si—O-based compounds, and compounds which have a garnet-type structure including Li, La, and Zr.

The solid electrolyte layer 12 preferably contains a lithium-containing phosphate compound as a solid electrolyte, and further, the lithium-containing phosphate compound preferably contains a lithium-containing phosphate compound having a NASICON-type structure. The lithium-containing phosphate compound having a NASICON-type structure is represented by the chemical formula LiₓM_{y}(PO₄)₃ (wherein x is a numerical value within the range of 1≦x≦3, y is a numerical value within the range of 1≦y≦2, and M is one or more elements selected from the group consisting of Ge, Al, Ga, Zr, Fe, and Nb). In this case, some of P may be substituted with B, Si, or the like in the above chemical formula. For example, Li_{1.5}Al_{0.5}Ge_{1.5}(PO₄)₃, Li_{3.0}Fe_{1.8}Zr_{0.2}(PO₄)₃. etc. can be used. Alternatively, a mixture may be used which has two or more mixed lithium-containing phosphate compounds having NASICON-type structures with different compositions.

Compounds including a crystalline phase of a lithium-containing phosphate compound having a NASICON-type structure, or glass for precipitating a crystalline phase of a lithium-containing phosphate compound having a NASICON-type structure through a heat treatment may be used as the lithium-containing phosphate compound having a NASICON-type structure, which is used for the solid electrolyte described above.

It is to be noted that it is possible to use, as the material used for the solid electrolyte, materials which have ion conductivity and have negligibly low electron conductivity, besides the lithium-containing phosphate compound having a NASICON-type structure. Examples of these materials include lithium halides, lithium nitrides, lithium oxoates, and derivatives thereof. In addition, examples of the materials can also include Li—P—O-based compounds such as lithium phosphate (Li₂PO₄), LIPON (LiPO₄₋ₓNₓ) of lithium phosphate with nitrogen introduced therein, Li—Si—O-based compounds such as Li₄SiO₄, Li—P—Si—O-based compounds, Li—V—Si—O-based compounds, compounds such as La_{2.51}Li_{0.35}TiO_{2.94}, La_{2.55}Li_{0.35}TiO₂, and Li₃ₓLa_{2/3-x}TiO₃ having a perovskite-type structure, and compounds which have a garnet-type structure including Li, La, and Zr.

There is no limit on the type of the electrode active material contained in the positive electrode layer 11 of the all solid state battery 10 according to the present invention. Lithium-containing phosphate compounds having a NASICON-type structure, such as Li₂V₂(PO₄)₃; lithium-containing phosphate compounds having an olivine-type structure, such as LiFePO₄ and LiMnPO₄; layered compounds such as LiCoO₂ and LiCo_{1/3}Ni_{1/3}Mn_{1/3}O₂; and lithium-containing compounds having a spinel-type structure, such as LiMn₂O₄ and LiNi_{0.5}Mn_{1.5}O₄ can be used as the positive electrode active material.

At least one of the positive electrode layer 11 and the negative electrode layer 13 is preferably bonded to the solid electrolyte layer 12 by stacking more than one green sheets to form a laminated body, and subjecting the laminated body to firing. In this case, at least one of the positive electrode layer 11 and the negative electrode layer 13 can be bonded to the solid electrolyte layer 12 integrally by firing, and it is thus possible to prepare an all solid state battery more inexpensively.

Further, the positive electrode layer 11 and the negative electrode layer 13 may contain a conducting agent, in addition to the electrode active material. Examples of the conducting agent include carbon materials and metal materials.

The all solid state battery 10 according to the present invention is produced as follows as an example.

First, a powder for the electrode active material and a powder for the solid electrolyte are prepared. Next, a slurry is prepared for each of the solid electrolyte layer 12, the positive electrode layer 11, and the negative electrode layer 13. Then, each of the slurries for the solid electrolyte layer 12, the positive electrode layer 11, and the negative electrode layer 13 is subjected to shape forming to prepare green sheets. Then, the green sheets for the solid electrolyte layer 12, the positive electrode layer 11, and the negative electrode layer 13 are stacked to form a laminated body. Next, the laminated body is subjected to firing. The firing bonds the positive electrode layer 11 and the negative electrode layer 13 to the solid electrolyte layer 12. Finally, the fired laminated body is sealed in, for example, a coin cell. The method for sealing is not particularly limited. For example, the fired laminated body may be sealed with a resin. Alternatively, sealing may be carried out by applying an insulator paste such as Al₂O₃, which has an insulating property, around the laminated body, or dipping the laminated body in the insulator paste, and subjecting this insulating paste to a heat treatment.

Further, in order to efficiently extract electric current from the positive electrode layer 11 and the negative electrode layer 13, a conductive layer such as a metallic layer may be formed on the positive electrode layer 11 and the negative electrode layer 13. Examples of the method for forming the conductive layer include a sputtering method. Alternatively, a metallic paste may be applied or used for dipping, and this metallic paste may be subjected to a heat treatment.

While the method for forming the green sheets is not particularly limited, a die coater, a comma coater, screen printing, etc. can be used. While the method for stacking the green sheets is not particularly limited, hot isostatic press (HIP), cold isostatic press (CIP), warm isostatic press (WIP), etc. can be used to stack the green sheets.

The slurry for forming the green sheet can be prepared by wet mixing of: an organic vehicle with a polymer material dissolved in a solvent; and a positive electrode active material powder, a negative electrode active material powder, a solid electrolyte powder, or a current collector material powder. In the wet mixing, media can be used, and specifically, a ball mill method, a visco mill method, etc. can be used. On the other hand, a wet mixing method may be used without using media, and a sand mill method, a high-pressure homogenizer method, a kneader dispersion method, etc. can be used.

The slurry may contain a plasticizer. While the type of the plasticizer is not particularly limited, phthalate esters such as dioctyl phthalate and diisononyl phthalate may be used.

While the atmosphere is not particularly limited in the firing step, the firing step is preferably carried out under the condition that the valence of a transition metal contained in the electrode active material undergoes no change.

Next, examples of the present invention will be described specifically. It is to be noted that the following examples are by way of example, the present invention is not to be considered limited to the following examples, and any modifications can be made without damaging the effect of the all solid state battery according to the present invention.

### EXAMPLES

All solid state batteries according to Examples 1 to 7 and Comparative Examples 1 to 5 were prepared as follows with the use of various types of electrode active materials and solid electrolytes.

### Example 1

### Preparation of Electrode Layer Sheet and Solid Electrolyte Layer Sheet

First, in order to prepare an all solid state battery, an electrode layer sheet and a solid electrolyte layer sheet were prepared as follows.

First, an anatase-type titanium oxide (TiO₂) powder was prepared as an electrode active material, whereas a glass powder of Li_{1.5}Al_{0.5}Ge_{1.5}(PO₄)₃ (hereinafter, referred to as “LAGP”) for precipitating a crystalline phase of a lithium-containing phosphate compound with a NASICON-type structure was prepared as a solid electrolyte.

Next, the anatase-type titanium oxide powder was mixed with a binder solution to prepare an electrode active material slurry. In addition, the glass powder of LAGP and a binder solution were mixed to prepare a solid electrolyte slurry. Furthermore, a carbon powder and a binder solution were mixed to prepare a carbon slurry. It is to be noted that the binder solution was prepared by dissolving polyvinyl alcohol in an organic solvent.

The obtained electrode active material slurry, solid electrolyte slurry, and carbon slurry were mixed to prepare an electrode layer slurry. The mixing ratio among the glass powder of LAGP, the anatase-type titanium oxide powder, and the carbon powder was adjusted to 45:45:10 in terms of parts by weight.

The obtained electrode layer slurry and solid electrolyte slurry were each formed by a doctor blade method into compacts of an electrode layer sheet and of a solid electrolyte layer sheet. The compacts were adjusted to 50 μm in thickness.

<Preparation of All Solid State Battery>

The solid electrolyte layer sheet and electrode layer sheet obtained in the way described above were used to prepare an all solid state battery.

First, a laminated body was prepared which had the electrode layer and solid electrolyte layer stacked. Specifically, the electrode layer sheet cut into a circular shape of 12 mm in diameter was stacked on one surface of the solid electrolyte layer sheet cut into a circular shape of 12 mm in diameter, and subjected to thermocompression bonding by applying a pressure of 1 ton at a temperature of 80° C.

Next, this laminated body was subjected to firing under the following conditions. First, the removal of polyvinyl alcohol was carried out by firing at a temperature of 500° C. in an oxygen gas atmosphere. Then, the electrode layer was bonded to the solid electrolyte layer by firing at a temperature of 600° C. in a nitride gas atmosphere. Then, the fired laminated body was dried at a temperature of 100° C. to remove moisture.

Then, the laminated body was stacked with a metal lithium plate as an opposite electrode. First, a polymethyl methacrylate resin (hereinafter, referred to as “PMMA”) gel compound was applied onto the metal lithium plate prepared as a positive electrode. Then, the laminated body and the metal lithium plate were stacked so that the surface of the fired laminated body on the solid electrolyte layer side was brought into contact with the coated surface. Then, sealing with a 2032-type coin cell was carried out to prepare an all solid state battery.

<Evaluation of All Solid State Battery>

The obtained all solid state battery was charged and discharged with a constant current and a constant voltage, at a current density of 50 μA/cm² in a voltage range of 1.0 to 3.0 V. As a result, it has been confirmed that it is possible to carry out charge and discharge with a discharge capacity of approximately 150 mAh/g.

In addition, the obtained all solid state battery was charged and discharged with a constant current and a constant voltage, at a current density of 50 μA/cm² in a voltage range of 1.4 to 3.0 V. As a result, the discharge capacity in the first cycle was 138 mAh/g, the discharge capacity in the fifth cycle was 132 mAh/g, and the cycle efficiency was 96%.

<Preparation and Evaluation of Battery Using Electrolyte Solution>

As a reference, a battery using an electrolyte solution in place of the solid electrolyte was prepared and evaluated.

First, an anatase-type titanium oxide powder, a carbon powder, and polytetrafluoroethylene (hereinafter, referred to as “PTFE”) were weighed so as to provide a compounding ratio of anatase-type titanium oxide:carbon powder:PTFE=70:20:10, and then subjected to wet mixing. Then, the mixture elongated with an extension bar was cut into a circular shape of 12 mm in diameter to prepare an electrode layer sheet.

Next, the electrode layer sheet was dried at a temperature of 100° C. to remove moisture. Then, a separator and a metal lithium plate for a positive electrode were stacked sequentially. Then, sealing with a 2032-type coin cell impregnated with an organic electrolyte solution was carried out to prepare a battery.

The obtained battery was charged and discharged with a constant current and a constant voltage, at a current density of 50 μA/cm² in a voltage range of 1.0 to 3.0 V. As a result, it has been confirmed that it is possible to carry out charge and discharge with a discharge capacity of approximately 150 mAh/g.

### Example 2

In Example 2, brookite-type titanium oxide was used in place of anatase-type titanium oxide (TiO₂) used as the electrode active material in Example 1. The other conditions for preparation were set in the same way as in Example 1 to prepare an all solid state battery.

<Evaluation of All Solid State Battery>

The obtained all solid state battery was charged and discharged with a constant current and a constant voltage, at a current density of 50 μA/cm² in a voltage range of 1.0 to 3.0 V. As a result, it has been confirmed that it is possible to carry out charge and discharge with a discharge capacity of approximately 100 mAh/g, and the same level of capacity is provided as in the case of the battery using the electrolyte solution.

### Example 3

In Example 3, a molybdenum dioxide (MoO₂) powder was used in place of the anatase-type titanium oxide (TiO₂) powder used as the electrode active material in Example 1. The other conditions for preparation were set in the same way as in Example 1 to prepare an all solid state battery.

<Evaluation of All Solid State Battery>

The obtained all solid state battery was charged and discharged with a constant current and a constant voltage, at a current density of 50 μA/cm² in a voltage range of 1.0 to 3.0 V. As a result, it has been confirmed that it is possible to carry out charge and discharge with a discharge capacity of approximately 200 mAh/g, and the same level of capacity is provided as in the case of the battery using the electrolyte solution.

In addition, the obtained all solid state battery was charged and discharged with a constant current and a constant voltage, at a current density of 50 μA/cm² in a voltage range of 1.4 to 3.0 V. As a result, the discharge capacity in the first cycle was 200 mAh/g, the discharge capacity in the fifth cycle was 198 mAh/g, and the cycle efficiency was 99%.

### Example 4

In Example 3, a chromium oxide (Cr₂O₃) powder was used in place of the anatase-type titanium oxide (TiO₂) powder used as the electrode active material in Example 1. The other conditions for preparation were set in the same way as in Example 1 to prepare an all solid state battery.

<Evaluation of All Solid State Battery>

The obtained all solid state battery was charged and discharged with a constant current and a constant voltage, at a current density of 50 μA/cm² in a voltage range of 0.2 to 3.0 V. As a result, it has been confirmed that it is possible to carry out charge and discharge with a discharge capacity of approximately 500 mAh/g, and the same level of capacity is provided as in the case of the battery using the electrolyte solution.

### Example 5

In Example 4, a tin dioxide (SnO₂) powder was used in place of the anatase-type titanium oxide (TiO₂) powder used as the electrode active material in Example 1. The other conditions for preparation were set in the same way as in Example 1 to prepare an all solid state battery.

<Evaluation of All Solid State Battery>

The obtained all solid state battery was charged and discharged with a constant current and a constant voltage, at a current density of 50 μA/cm² in a voltage range of 0.2 to 3.0 V. As a result, it has been confirmed that it is possible to carry out charge and discharge with a discharge capacity of approximately 1500 mAh/g, and the same level of capacity is provided as in the case of the battery using the electrolyte solution.

In addition, the obtained all solid state battery was charged and discharged with a constant current and a constant voltage, at a current density of 50 μA/cm² in a voltage range of 0.2 to 3.0 V. As a result, the discharge capacity in the first cycle was 1500 mAh/g, the discharge capacity in the fifth cycle was 1440 mAh/g, and the cycle efficiency was 96%.

From the evaluations of the all solid state batteries according to Examples 1 to 5, it has been clarified that it is possible to carry out charge and discharge on the same level as a battery with an electrolyte solution, as long as the structures of the electrode active material powder and solid electrolyte powder are maintained during the firing of the positive electrode layer and negative electrode layer, so as not to produce any heterophase or structural change.

### Example 6

### Preparation of Electrode Layer Sheet and Solid Electrolyte Layer Sheet

First, in order to prepare an all solid state battery, an electrode layer sheet and a solid electrolyte layer sheet were prepared as follows.

First, a silicon monoxide (SiO) powder was prepared as an electrode active material, a glass powder of LAGP for precipitating a crystalline phase of a lithium-containing phosphate compound with a NASICON-type structure was prepared as a solid electrolyte, and a carbon powder was prepared as a conducting agent.

Next, the silicon monoxide powder and a binder solution were mixed to prepare an electrode active material slurry. In addition, the glass powder of LAGP and a binder solution were mixed to prepare a solid electrolyte slurry. Furthermore, the carbon powder was mixed with a binder solution to prepare a carbon slurry.

Then, the obtained electrode active material slurry, solid electrolyte slurry, and carbon slurry were mixed to prepare an electrode layer slurry. The mixing ratio among the silicon monoxide powder, the glass powder of LAGP, and the carbon powder was adjusted to 45:45:10 in terms of parts by weight.

The obtained electrode layer slurry and solid electrolyte slurry were each formed by a doctor blade method into compacts of an electrode layer sheet and of a solid electrolyte layer sheet. The compacts were adjusted to 50 μm in thickness.

<Preparation of All Solid State Battery>

The solid electrolyte layer sheet and electrode layer sheet obtained in the way described above were used to prepare an all solid state battery.

First, a laminated body was prepared which had the electrode layer and solid electrolyte layer stacked. Specifically, the electrode layer sheet cut into a circular shape of 12 mm in diameter was stacked on one surface of the solid electrolyte layer sheet cut into a circular shape of 12 mm in diameter, and subjected to thermocompression bonding by applying a pressure of 1 ton at a temperature of 80° C.

Next, this laminated body was subjected to firing under the following conditions. First, the removal of polyvinyl alcohol was carried out by firing at a temperature of 500° C. in an oxygen gas atmosphere. Then, the electrode layer was bonded to the solid electrolyte layer by firing at a temperature of 600° C. in a nitride gas atmosphere. Then, the fired laminated body was dried at a temperature of 100° C. to remove moisture.

Then, the laminated body was stacked with a metal lithium plate as an opposite electrode. First, a PMMA gel compound was applied onto the metal lithium plate prepared as a positive electrode. Then, the laminated body and the metal lithium plate were stacked on the coated surface so that the surface of the fired laminated body on the solid electrolyte layer side was brought into contact with the coated surface. Then, the laminated body obtained was sealed with a 2032-type coin cell to prepare an all solid state battery.

<Evaluation of All Solid State Battery>

The obtained all solid state battery was charged and discharged with a constant current and a constant voltage, at a current density of 50 μA/cm² in a voltage range of 0.2 to 3.0 V. As a result, the discharge capacity in the first cycle was 805 mAh/g, the discharge capacity in the fifth cycle was 773 mAh/g, and the cycle efficiency was 96%.

### Comparative Example 1

### Preparation of Electrode Layer Sheet and Solid Electrolyte Layer Sheet

In the same way as in Example 6, an electrode layer sheet and a solid electrolyte layer sheet were prepared. A glass powder of Li_{1.5}Al_{0.5}Ti_{1.5}(PO₄)₃ (hereinafter, referred to as “LATP”) for precipitating a crystalline phase of a lithium-containing phosphate compound with a NASICON-type structure was prepared as a solid electrolyte.

The glass powder of LATP and a binder solution were mixed to prepare a solid electrolyte slurry.

Next, the obtained solid electrolyte slurry was mixed with the electrode active material slurry according to Example 6 and the carbon slurry to prepare an electrode layer slurry. The mixing ratio among the silicon monoxide powder, the glass powder of LATP, and the carbon powder was adjusted to 45:45:10 in terms of parts by weight.

The obtained electrode layer slurry and solid electrolyte slurry were each formed by a doctor blade method into compacts of an electrode layer sheet and of a solid electrolyte layer sheet. The compacts were adjusted to 50 μm in thickness.

<Preparation of All Solid State Battery>

The obtained electrode layer sheet and solid electrolyte layer sheet were used to prepare an all solid state battery in the same way as in Example 6.

The laminated body was subjected to firing under the following conditions. First, the removal of polyvinyl alcohol was carried out by firing at a temperature of 500° C. in an oxygen gas atmosphere. Then, the electrode layer was bonded to the solid electrolyte layer by firing at a temperature of 900° C. in a nitride gas atmosphere. Then, the fired laminated body was dried at a temperature of 100° C. to remove moisture.

<Evaluation of All Solid State Battery>

The obtained all solid state battery was charged and discharged with a constant current and a constant voltage, at a current density of 50 μA/in a voltage range of 0.2 to 3.0 V. As a result, the discharge capacity in the first cycle was 783 mAh/g, the discharge capacity in the fifth cycle was 420 mAh/g, and the cycle efficiency was 54%.

### Example 7

### Preparation of Electrode Layer Sheet and Solid Electrolyte Layer Sheet

In the same way as in Example 6, an electrode layer sheet and a solid electrolyte layer sheet were prepared.

First, a niobium pentoxide (Nb₂O₅) powder was prepared as an electrode active material, whereas a glass powder of Li_{3.0}Fe_{1.8}Zr_{0.2}(PO₄)₃ (hereinafter, referred to as “LFZP”) for precipitating a crystalline phase of a lithium-containing phosphate compound with a NASICON-type structure was prepared as a solid electrolyte.

Next, the niobium pentoxide powder and a binder solution were mixed to prepare an electrode active material slurry. In addition, the glass powder of LFZP and a binder solution were mixed to prepare a solid electrolyte slurry.

Then, the obtained electrode active material slurry, solid electrolyte slurry, and carbon slurry were mixed to prepare an electrode layer slurry. The mixing ratio among the niobium pentoxide powder, the glass powder of LFZP, and the carbon powder was adjusted to 45:45:10 in terms of parts by weight.

The obtained electrode layer slurry and solid electrolyte slurry were each formed by a doctor blade method into compacts of an electrode layer sheet and of a solid electrolyte layer sheet. The compacts were adjusted to 50 μm in thickness.

<Preparation of All Solid State Battery>

The obtained electrode layer sheet and solid electrolyte layer sheet were used to prepare an all solid state battery in the same way as in Example 6. It is to be noted that the firing in a nitride gas atmosphere was carried out at a temperature of 900° C.

<Evaluation of All Solid State Battery>

The obtained all solid state battery was charged and discharged with a constant current and a constant voltage, at a current density of 50 μA/cm² in a voltage range of 1.4 to 3.0 V. As a result, the discharge capacity in the first cycle was 200 mAh/g, the discharge capacity in the fifth cycle was 196 mAh/g, and the cycle efficiency was 98%.

### Comparative Example 2

### Preparation of Electrode Layer Sheet and Solid Electrolyte Layer Sheet

In the same way as in Example 7, an electrode layer sheet and a solid electrolyte layer sheet were prepared. A glass powder of LATP was prepared as a solid electrolyte.

The glass powder of LATP and a binder solution were mixed to prepare a solid electrolyte slurry.

Next, the obtained solid electrolyte slurry was mixed with the electrode active material slurry according to Example 7 and the carbon slurry to prepare an electrode layer slurry. The mixing ratio among the niobium pentoxide powder, the glass powder of LATP, and the carbon powder was adjusted to 45:45:10 in terms of parts by weight.

The obtained electrode layer slurry and solid electrolyte slurry were each formed by a doctor blade method into compacts of an electrode layer sheet and of a solid electrolyte layer sheet. The compacts were adjusted to 50 μm in thickness.

<Preparation of All Solid State Battery>

The obtained electrode layer sheet and solid electrolyte layer sheet were used to prepare an all solid state battery in the same way as in Example 7.

<Evaluation of All Solid State Battery>

The obtained all solid state battery was charged and discharged with a constant current and a constant voltage, at a current density of 50 μA/cm² in a voltage range of 1.4 to 3.0 V. As a result, the discharge capacity in the first cycle was 191 mAh/g, the discharge capacity in the fifth cycle was 131 mAh/g, and the cycle efficiency was 69%.

### Comparative Example 3

An all solid state battery was prepared in the same way as in Comparative Example 1, except that the anatase-type titanium oxide powder used in Example 1 was used as an electrode active material.

<Evaluation of All Solid State Battery>

The obtained all solid state battery was charged and discharged with a constant current and a constant voltage, at a current density of 50 μA/cm² in a voltage range of 1.4 to 3.0 V. As a result, the discharge capacity in the first cycle was 149 mAh/g, the discharge capacity in the fifth cycle was 99 mAh/g, and the cycle efficiency was 66%.

### Comparative Example 4

An all solid state battery was prepared in the same way as in Comparative Example 1, except that the molybdenum dioxide powder used in Example 3 was used as an electrode active material.

<Evaluation of All Solid State Battery>

The obtained all solid state battery was charged and discharged with a constant current and a constant voltage, at a current density of 50 μA/cm² in a voltage range of 1.4 to 3.0 V. As a result, the discharge capacity in the first cycle was 222 mAh/g, the discharge capacity in the fifth cycle was 148 mAh/g, and the cycle efficiency was 67%.

### Comparative Example 5

An all solid state battery was prepared in the same way as in Comparative Example 1, except that the tin dioxide powder used in Example 5 was used as an electrode active material.

<Evaluation of All Solid State Battery>

The obtained all solid state battery was charged and discharged with a constant current and a constant voltage, at a current density of 50 μA/cm² in a voltage range of 0.2 to 3.0 V. As a result, the discharge capacity in the first cycle was 1413 mAh/g, the discharge capacity in the fifth cycle was 820 mAh/g, and the cycle efficiency was 58%.

From the evaluations of the all solid state batteries according to Examples 6 and 7 and Comparative Examples 1 and 2 and the evaluations of the all solid state batteries according to Examples 1, 3, and 5 and Comparative Examples 3, 4, and 5, it has been confirmed that the preparation of an all solid state battery with the use of the metal oxide containing no lithium as the electrode active material for the negative electrode, and with the use of the solid electrolyte containing no titanium for the negative electrode makes it possible to achieve an all solid state battery with a high cycle efficiency and improved cycle stability.

The embodiments and examples disclosed herein are all to be considered by way of example in all respects, but not limiting. The scope of the present invention is defined by the claims, but not by the embodiments and examples described above, and intended to encompass all modifications and changes within the spirit and scope equivalent to the claims.

The all solid state battery prepared with the use of a metal oxide containing no lithium as an electrode active material for a negative electrode, and with the use of a solid electrolyte containing no titanium for the negative electrode, not only has the same level of discharge capacity as in the case of using an electrolyte solution, but also has improved cycle stability, and thus, the present invention can provide an all solid state battery which has high battery performance.

### DESCRIPTION OF REFERENCE SYMBOLS

10 all solid state battery
11 positive electrode layer
12 solid electrolyte layer
13 negative electrode layer

1. An all solid state battery comprising:
a positive electrode layer;
a negative electrode layer; and
a solid electrolyte layer interposed between the positive electrode layer and the negative electrode layer,
wherein at least one of the positive electrode layer and the negative electrode layer is a firing-bonded layer which was bonded to the solid electrolyte layer by firing, and
wherein the negative electrode layer contains an electrode active material comprising a metal oxide containing no lithium, and a solid electrolyte containing no titanium.

2. The all solid state battery according to claim 1, wherein the metal oxide comprises at least one element selected from the group consisting of titanium, silicon, tin, chromium, iron, molybdenum, niobium, nickel, manganese, cobalt, copper, tungsten, vanadium, and ruthenium.

3. The all solid state battery according to claim 1, wherein the metal oxide is a compound represented by MOₓ, wherein M is at least one element selected from the group consisting of Ti, Si, Sn, Cr, Fe, Mo, Nb, Ni, Mn, Co, Cu, W, V, and Ru, and 0.5≦x≦3.0.

4. The all solid state battery according to claim 3, wherein the compound is selected from the group consisting of anatase-type TiO₂, rutile-type TiO₂, brookite-type TiO₂, SiO, SnO, SnO₂, Cr₂O₃, Fe₂O₃, MoO₂, Nb₂O₅, NiO, MnO, CoO, Cu₂O, CuO, WO₂, V₂O₅, and RuO₂.

5. The all solid state battery according to claim 2, wherein the solid electrolyte containing no titanium contains a lithium-containing phosphate compound.

6. The all solid state battery according to claim 1, wherein the solid electrolyte containing no titanium contains a lithium-containing phosphate compound.

7. The all solid state battery according to claim 1, wherein the solid electrolyte containing no titanium contains a lithium-containing phosphate compound having a NASICON-type structure.

8. The all solid state battery according to claim 1, wherein the solid electrolyte contained in the solid electrolyte layer contains a lithium-containing phosphate compound.

9. The all solid state battery according to claim 8, wherein the lithium-containing phosphate compound contained in the solid electrolyte layer contains a lithium-containing phosphate compound having a NASICON-type structure.

10. The all solid state battery according to claim 2, wherein the solid electrolyte contained in the solid electrolyte layer contains a lithium-containing phosphate compound.

11. The all solid state battery according to claim 5, wherein the solid electrolyte contained in the solid electrolyte layer contains a lithium-containing phosphate compound.

12. The all solid state battery according to claim 6, wherein the solid electrolyte contained in the solid electrolyte layer contains a lithium-containing phosphate compound.
